(19) United States
(12) Patent Application Publication
(10) Pub. No.: US 2010/0246864 A1
(43) Pub. Date: Sep. 30, 2010

(54) HEADPHONE IMPROVEMENTS

(76) Inventors: James G. Hildebrandt, Calgary (CA); Brendon Cook, Calgary (CA)

Correspondence Address: WINSTON & STRAWN LLP;PATENT DEPARTMENT, 1700 K STREET, N.W., WASHINGTON, DC, 20006, US

(21) Appl. No.: 12/375,392

(22) PCT Filed: Jul. 30, 2007
(86) PCT No.: PCT/CA2007/001331

§ 371 Date: Jun. 10, 2010

Related U.S. Application Data
(60) Provisional application No. 60/833,775, filed on Jul. 28, 2006.

(51) Int. Cl. H04R 5/033; H04R 1/10

(52) U.S. Cl. 381/310; 381/87; 381/104

(57) ABSTRACT

A method of providing an audio signal to a headphone apparatus for a user is disclosed. The method comprises providing a headphone apparatus comprising at least one left speaker for a left ear of a user having a sound path from the left speaker to the left ear canal and at least one right speaker for a right ear of the user having a sound path from the right speaker to the right ear canal, wherein the sound path of the left speaker has a different length from the sound path of the right speaker. The method further comprises sending an audio signal simultaneously to the left speaker and right speaker thereby creating a timing difference in the time the signal is received by each ear canal based on the difference is the length of the sound path.

### TECHNICAL FIELD

The present invention relates to headphones, and more particularly to various improvements to headphones.

### BACKGROUND

Conventional headphones have been found to embody numerous limitations that inhibit sound quality and user satisfaction. For example, headphones employing ear cups suffer from a lack of air circulation around the user's ear. Also, it has been found that some headphones attempting to provide “surround sound” effects (by using digital signal processor, or DSP, methods to alter the frequency response curve) generate an unrealistic effect that negatively impacts on the listening experience. The typical method for adjusting frequency equalization using DSP methods has also been found to be inconvenient for users. In addition, in-ear headphones have become increasingly popular, but they are often found to be uncomfortable and are prone to falling out of the user's ear.

Finally, most existing headphones fail to produce an adequate sense of sound directionality. Canadian Patent Application No. 2,432,832 (the prior Hildebrandt application), with an inventor in common with the present application, teaches a headphone apparatus that seeks to achieve three-dimensional sound effects using tubing connected to the speakers. However, certain tubing sizes were found to create an undesirable resonance that impacted sound quality.

While many improved headphones have accordingly been proposed, limitations still exist.

What are needed, therefore, are headphones or methods of use which can counter at least one of these limitations and enhance sound quality and user enjoyment.

### SUMMARY OF THE INVENTION

The present invention accordingly seeks to provide novel headphone apparatus and methods for enhancing sound quality and user enjoyment.

According to a first aspect of the present invention, there are provided air circulation control means for use with a headphone apparatus.

According to a second aspect of the present invention, there is provided an apparatus and method for using frequency response curves with headphones to emulate surround sound effects.

According to a third aspect of the present invention, there is provided a headphone apparatus for in-ear positioning.

According to a fourth aspect of the present invention, there is provided a method for adjusting frequency equalization.

According to a fifth aspect of the present invention, there are provided means for delivering acoustic signals to a user's ears such that acoustic source spatial location is emulated.

According to a sixth aspect, there is provided a method creating a net frequency response curve in a headphone apparatus comprising:
providing at least a first and a second speaker for at least one channel of sound, the first speaker having a different frequency response curve to that of the second speaker;
providing a signal directly to each speaker without the use of a cross-over circuit;
whereby the net frequency response curve is created based on the different frequency response curves of each speaker.

The sixth aspect may further include either the first or second speaker having a volume control means for adjusting the amplitude of the associated speaker.

The sixth aspect may further be defined wherein more than one speaker has a volume control means for independently adjusting the amplitude of the associated speaker.

The sixth aspect may further include a coupled volume control for adjusting the amplitude of at least the first speaker and the second speaker in substantially opposite amplitudes so that the overall amplitude level is substantially maintained.

The sixth aspect may further be defined wherein the first speaker has an elevated amplitude for a first frequency band and the second speaker has an elevated amplitude for a second frequency band and wherein at least a portion of the first and second frequency bands do not overlap.

The sixth aspect may further be defined wherein two channels of sound are provided and each channel has at least two speakers, each having a different frequency response curve.

The sixth aspect may further be defined wherein at least three channels of sound are provided and each channel has at least two speakers, each having a different frequency response curve.

According to a seventh aspect, there is provided a method of providing an audio signal to a user in a headphone apparatus, the method comprising:
providing a headphone apparatus comprising at least one left speaker for a left ear of a user having a sound path from the left speaker to the left ear canal and at least one right speaker for a right ear of the user having a sound path from the right speaker to the right ear canal, wherein the sound path of the left speaker has a different length from the sound path of the right speaker; and
sending an audio signal simultaneously to the left speaker and right speaker thereby creating a timing difference in the time the signal is received by each ear canal based on the difference is the length of the sound path.

The seventh aspect may further be defined, wherein the audio signal for the left and right speakers is the same.

According to a eighth aspect, there is provided a method of providing an audio signal to a user in a headphone apparatus, the method comprising:
providing at least two channels of audio signal;
providing a headphone apparatus comprising a left speaker and a right speaker for each channel, each of the left speakers having a sound path from the left speaker to the left ear canal and each of the right speakers having a sound path from the right speaker to the right ear canal, wherein the sound path for the left speaker of a channel has a different length than the sound path for the right speaker of the channel unless the channel is an audio signal for a center channel; and
wherein each channel is sent simultaneously to the corresponding left and right speaker associated with that channel.

The eighth aspect may further be defined wherein a first and a second audio channel are provided;
the left speaker for a first audio channel has a sound path length of X, the right speaker for a first audio channel has a sound path length of Y, the left speaker for the second audio channel has a sound path length of Y and the right speaker for the second audio channel has a sound path length of X, and X is different from Y.

The eighth aspect may further be defined wherein a third audio channel is provided and is a center channel;
the left and right speaker of the center channel each having substantially equal sound path lengths.

The eighth aspect may further be defined, wherein speakers having equal sound path lengths have the same frequency response curve which is unique to the frequency response curve of speakers having a different sound path length.

The eighth aspect may further include the step of:
providing a volume control means for adjusting the amplitude of at least one pair of speakers having the same frequency response curve.

The eighth aspect may further be defined, wherein a perceived sound angle from a center plane of a user's head is:

S=D/2(A+sin(A))

where
S is the sound path length difference between the left and right speakers of a channel;
D is the diameter of a user's head; and
A is the perceived sound angle.

The eighth aspect may further be defined, wherein the signal provided is a stereo signal and the headphone apparatus comprises two left speakers and two rights speakers.

The eighth aspect may further be defined, wherein the signal is a 5.1 signal and the headphone apparatus comprises five left speakers and five right speakers.

The eighth aspect may further be defined, wherein the headphone apparatus further comprises two base speakers.

The eighth aspect may further be defined, wherein the center channel comprises a front center and a rear center channel.

According to a ninth aspect, there is provided a headphone apparatus having an ear cup for cupping a user's ear and an air circulation control device for circulating air to at least a portion of a user's ear when the headphone apparatus is in place on the user, the device comprising:
an opening situated in the ear cup for allowing passage of air through the ear cup to at least a portion of a user's ear;
means for at least partially blocking the opening.

The ninth aspect may further be defined, wherein the means for at least partially blocking the opening is a removable cap adapted to fit into the opening and block air flow through the opening.

The ninth aspect may further be defined, wherein the means for at least partially blocking the opening is an adjustable door suitable for movement from an open position whereby the opening allows passage of air through the ear cup to at least a portion of a user's ear and a closed position whereby the door is moved over the opening and either partially or fully blocks the opening.

According to a tenth aspect, there is provided a headphone having an ear cup for cupping a user's ear and an air circulation control device for circulating air to at least a portion of a user's ear when the headphone apparatus is in place on the user, the device comprising:
a fan for blowing air;
a duct having one end for directing air at the user's ear and another end in communication with the fan such that operation of the fan blows air into the duct and causes circulation of air to at least a portion of the user's ear.

The tenth aspect may further be defined, wherein the duct is lined with sound-absorbing material.

A detailed description of exemplary embodiments of the present invention are given in the following. It is to be understood, however, that the invention is not to be construed as limited to these embodiments.

### BRIEF DESCRIPTION OF THE DRAWINGS

In the accompanying drawings, which illustrate exemplary embodiments of the present invention:

FIG. 1 is a side elevation view of a user's head provided with illustrative headphones, the headphones comprising air circulation control means;

FIG. 2 is a side elevation view of a user's head provided with illustrative headphones, the headphones comprising alternative air circulation control means;

FIG. 3 is a chart illustrating exemplary frequency response curves of use with the present invention;

FIG. 4 is a top plan view of in-ear headphones in accordance with an aspect of the present invention;

FIG. 5 is a top plan view of the in-ear headphones of FIG. 4 when worn by a user;

FIG. 6 is a side elevation view of the in-ear headphones of FIG. 4 when worn by a user;

FIG. 7 is a chart illustrating signal frequency at a first speaker volume;

FIG. 8 is a chart illustrating signal frequency at a second speaker volume;

FIG. 9 is a front elevation view of a user provided with an illustrative headphone apparatus according to an aspect of the present invention;

FIG. 10 is a side elevation view of the embodiment of FIG. 9;

FIG. 11 is a top plan view of a user's head illustrating user sound direction perception;

FIG. 12 is a front elevation view of a user provided with headphone apparatus according to an aspect of the present invention;

FIG. 13 is a side elevation view of the embodiment of FIG. 12;

FIG. 14 is a side elevation view of an alternative embodiment of the headphone apparatus of FIGS. 12 and 13;

FIG. 15 is a side elevation view of an alternative embodiment of headphone apparatus according to an aspect of the present invention;

FIG. 16 is a side elevation view of an alternative embodiment of headphone apparatus according to an aspect of the present invention;

FIG. 17 is a partial front elevation view of the embodiment of FIG. 16;

FIG. 18 is an overhead view of an illustrative embodiment of a headphone set; and

FIG. 19 is an overhead view of another illustrative embodiment of a headphone set.

### DETAILED DESCRIPTION

The drawings illustrate a number of alternative embodiments of aspects of the present invention. Exemplary embodiments of various improvements over existing headphone apparatus are provided below.

For the purposes of this specification, the term “speaker” encompasses any suitable sound source.

### Air Circulation

As described above, insufficient air circulation around the user's ear is apparent when headphones are employed that comprise ear cups. Headphones create a stagnant air pocket around or in the ear. The user usually takes off the headphones from time to time to air out the headphone. Another solution that is currently used is to create vents in the headphone ear cup.

According to the present invention, the proposed solution is to provide the user with control of the air circulation around or in the ear. The exemplary means include a removable ear cap or adjustable vents on the ear cup, or to have a fan blowing air into a duct to the ear cup. The use of an adjustable vent opening allows for air circulation and allows the user to control the amount of noise blocking provided by the headphone.

Creating a removable ear cap or user-controlled adjustable vents allows the user to control the timing and amount of air circulation in the ear cup. An alternative is to add a small fan to the headphone inside the ear cup, or outside the ear cup with a duct for the air to either blow fresh air into the ear cup or to suck out the warm air from the ear cup.

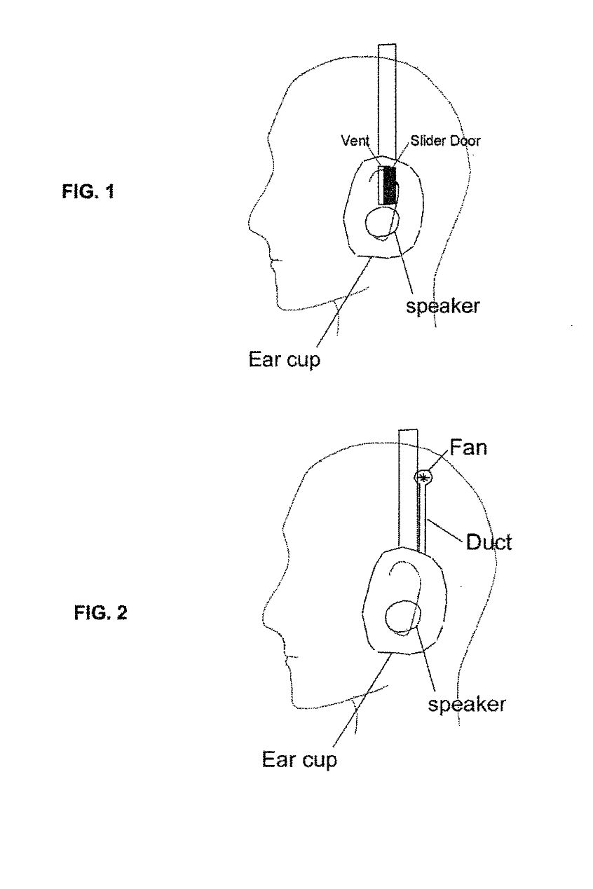

FIG. 1 shows a user with a circumaural headphone. The vertical vent represents the area where air can enter and leave the headphone to provide natural cooling. The dark grey section represents a slider door that the user can use to adjust the vent opening.

FIG. 2 shows a headphone with a fan and duct. The duct can be lined with a sound-absorbing material to minimize the sound from the fan.

### Surround Sound Headphone Effect

As described above, it has been found that current headphone apparatus do not provide a realistic surround sound effect, and it has generally been necessary to utilize DSP methods to emulate surround sound in headphones. One previous method for generating surround sound effects has been to use DSP methods to alter the frequency response curve for a conventional set of headphones (with one speaker at each ear of the user). The DSP method creates one frequency response curve for sounds that are supposed to be coming from in front of the user, and a different frequency response curve for sounds that are supposed to be coming from behind the user. Another known method is to position multiple speakers around each ear; this method tries to use placement of the speakers within the ear cup to emulate sounds from the front or rear.

This aspect of the present invention seeks to solve the lack of realistic surround sound in headphones. It also seeks to address the problem of needing to use DSP methods to emulate surround sound in headphones.

The present invention uses multiple speakers for each side, but the speakers each have a specific frequency response curve to emulate the front and rear sounds.

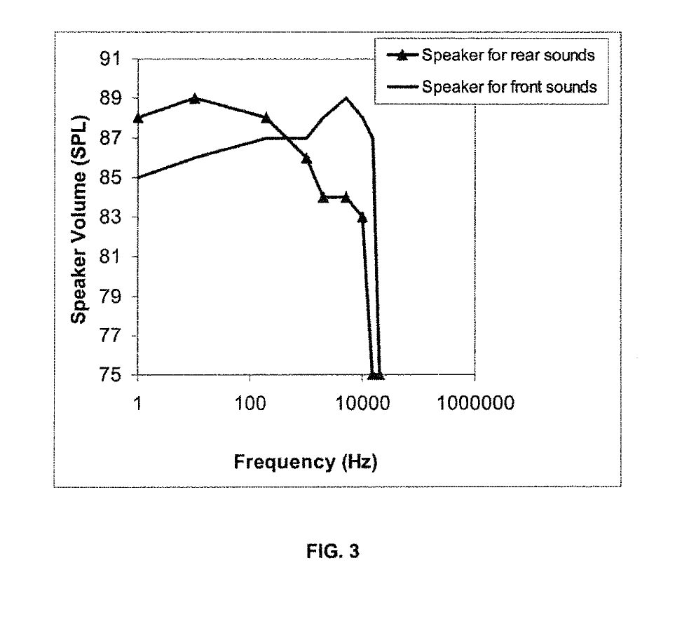

FIG. 3 shows an example of frequency response curves that could be used to represent the front and rear sounds. The speaker for the rear sounds has more strength in the lower frequencies, while the speaker for the front sounds has more strength in the higher frequencies. The shapes of these curves is for illustration of the principle only, and are not necessarily the most efficacious shapes in all situations.

For a surround sound headphone, the headphone speaker for the rear left sounds would be connected to the audio source of the rear left sounds. The speaker for the front left sounds would be connected to the audio source of the front left sounds.

### In-Ear Headphone

In-ear monitors and headphones that are placed inside the ear tend to be uncomfortable and are prone to falling out, as indicated above.

In-ear monitors are usually held in place by friction in the ear canal, or by some

material around the ear such as wires over the pinna of the ear. The pinna is the outer ear.

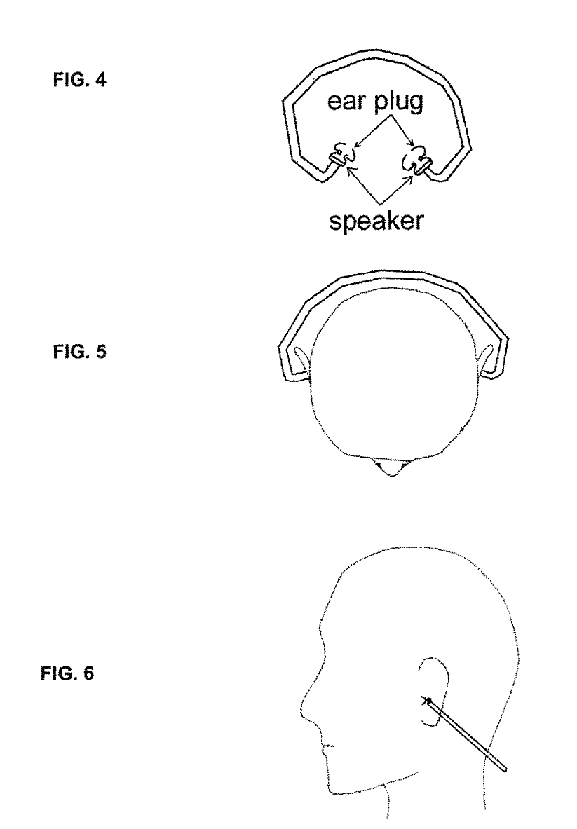

According to the present invention, a frame or band is used to connect the in-ear structures on the left and right ear, as can be seen in FIGS. 4, 5 and 6. One option is to use some pre-tensioning in the frame to comfortably hold the structures in place.

The frame structurally connects the left and right audio structures and provides pressure into the ear to hold the audio structures in place. The frame can be placed in many ways around the head, for example, around the back of the head (as shown), over the head, or under the chin (like a stethoscope).

### Frequency Equalization

Currently, the typical way to adjust frequency equalization (EQ) is to use DSP methods to change the volume ranges of frequencies for the signal going to a speaker system or headphone. Usually, the control for this is not convenient to the user, as it is located at the signal source.

The present invention instead employs volume control means on a pair of speakers to alter the perceived frequency amplitudes. Multiple speakers are provided for at least one channel of sound, where each speaker has a specific frequency response curve and at least one of the speakers has a volume control.

The advantages of such a method and apparatus include simplicity and allowing the EQ control to be within easier reach of the user. For example, for a headphone user, the proposed EQ control can be on the headphone cord and can therefore always be within easy reach of the user instead of the user needing to alter settings on the audio-producing device. For some uses (such as music)

the user may wish one EQ setting, while for other uses (such as video gaming) the user may wish another EQ setting. The present method can be undertaken at the headphone controls instead of at the source of the audio signal (e.g. computer or mp3 player).

This aspect of the present invention can be applied to any audio delivering system, such as room speakers, and need not be limited in application to headphones.

In an exemplary embodiment using headphones, the headphones would have at least two speakers for at least one signal (e.g. left and/or right channels). Each of these speakers would have a specific frequency response curve. A volume switch for at least one of these speakers would allow the user to adjust the signal strength to those speakers. For example, the left and right channel would each have a speaker that is stronger in the mid to high frequencies than in the low frequencies, and a speaker that has a frequency response curve that is stronger in the low frequencies than in the mid to high frequencies. The user could change the relative volume down for the low frequency speaker to hear relatively more mid to high frequencies, or raise the volume of the low frequency speaker to hear relatively more bass.

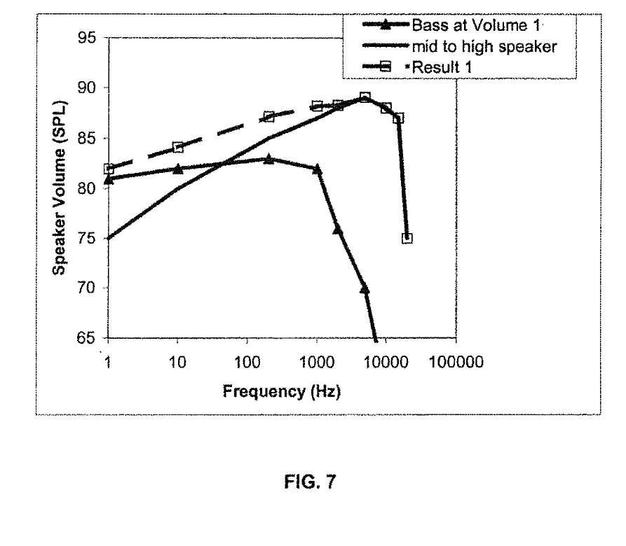

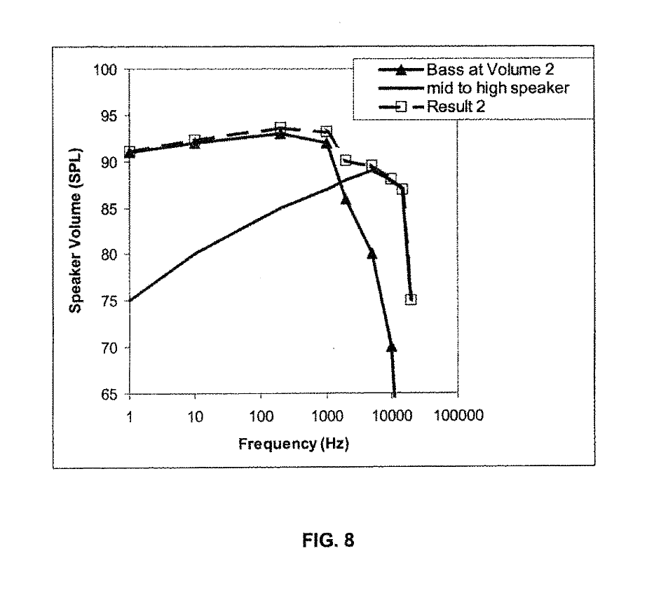

FIGS. 7 and 8 show the perceived result of the combinations of these conditions, shown with the dashed line.

This aspect of the present invention can also be accomplished with any number of speakers, each with its own complementary frequency response curve and volume control.

### Means for Providing Sense of Directionality

A final aspect of the present invention seeks to provide the headphone user with a sense of the direction from which the audio signals are being delivered.

Aside from the use of headphones, most sounds are delivered to each ear with a few differences between the left and right ears, and these differences are cues with which the brain can determine the location of the sound source. Sounds that the user can perceive in space sound richer and more pleasant than those that the brain cannot locate. One of the key cues to locate a sound source is the timing difference between the sound reaching the left and right ears.

Conventional headphones deliver a left signal only to the left ear and the right signal only to the right ear. Accordingly, there is no way the user can tell the direction of the sound source.

One prior method used to solve the problem of directionality has been to deliver each signal to both ears with some of the direction effect modified by electronics to create a time delay, and possibly an altered frequency-dependent volume change between the signals sent to the speakers placed at each ear.

As indicated above, the prior Hildebrandt application also provided a solution to this problem by employing tubing with speakers. However, it has been determined that there may be a problem with some tubing sizes in that the sounds create some undesirable resonance.

The present invention allows for eliminating some of the tubing used in the prior Hildebrandt application, which reduces the undesirable resonance sometimes found with embodiments of the earlier invention.

In exemplary embodiments, a speaker is provided for each ear and at least one of the speakers has a longer sound path to the ear than the other. In the prior Hildebrandt application there needed to be at least one speaker with one tube (sound path) to one ear and another tube (sound path) to the other ear.

The present invention involves creating a perception of a sound at a controlled angle from the front centre of the user's head. Psychoacoustic research indicates there are three cues the human brain uses to determine the location of sound:
1) Timing difference between the ears. The sound hits the ear nearest the sound before reaching the far ear.
2) Frequency-dependent volume difference between the ears. The head blocks the high frequency signal to the far ear.
3) Pinna effect. Sounds to the front of the person have some of the higher frequencies amplified compared to sounds coming from behind the person.

The exemplary embodiment of this aspect of the present invention involves sending an audio signal simultaneously to two speakers, where the sound path distance of one speaker to one ear is different than the sound path distance of the other speaker to the other ear. This difference in distance creates a timing difference between the ears, and the timing difference creates the impression that the signal is coming from a location to one side of the head. The larger the timing difference the greater the perceived angle from the center plane of the head. The perceived angle (A) is related to the path length difference (S) by the following formula:

S=D/2(A+sin(A))

where:
D is the diameter of the listener's head;
A is the perceived angle (in radians); and
S is the path distance between the left and right speakers that use the same signal.

As an example, for a person with a head diameter of 6 inches, and a path length from the left ear to the left speaker that is 3.07 inches closer than the path length from the right ear to the right speaker, the user will perceive the sound to be at a 30 degree angle left of the centre. For a person with a larger head and this combination of path lengths, the perceived angle will decrease slightly, while for a person with a smaller head the perceived angle will be slightly larger.

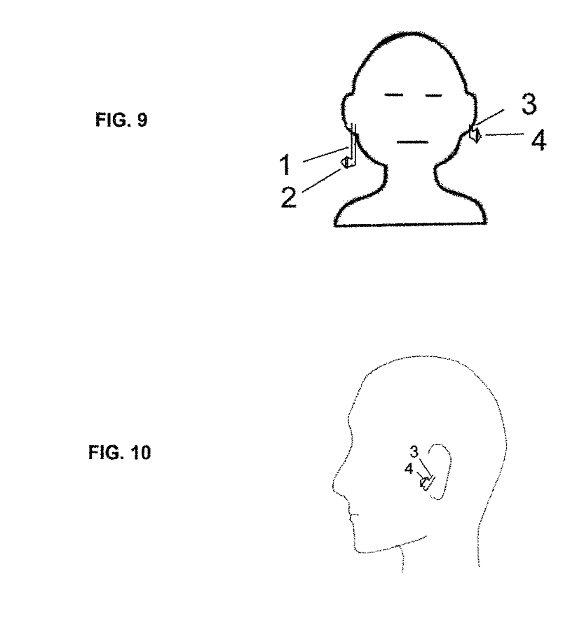

Referring to FIGS. 9 and 10, item 1 is a sound path that connects speaker 2 to the right ear. Item 3 is a shorter sound path that connects speaker 4 to the left ear. The speaker with the shorter sound path could also be simply placed in or at the ear. The difference between the length of sound path 1 and that of sound path 3 creates the perception of the sound being at a certain angle off of centre.

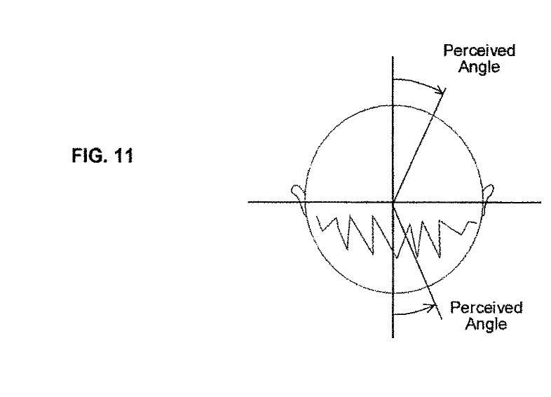

With only the timing difference, the sound is perceived to come from a cone. In the horizontal plane (i.e., top plan view) the angles can be shown as in FIG. 11.

In addition to the timing difference as described above, other modifications can be made to the signal to support the perceived location of the sound. The audio signal on the “near” ear can be modified to be louder than the signal to the “far” ear to correspond with the goal of making the perception of the sound source location as being to one side. Furthermore, the sound in the drivers can be modified to simulate the pinna effect by the use of higher volume of the higher frequencies for the sounds that represent the sounds at the front of the person, and lower volume of higher frequencies for sounds that are to represent sounds behind the person.

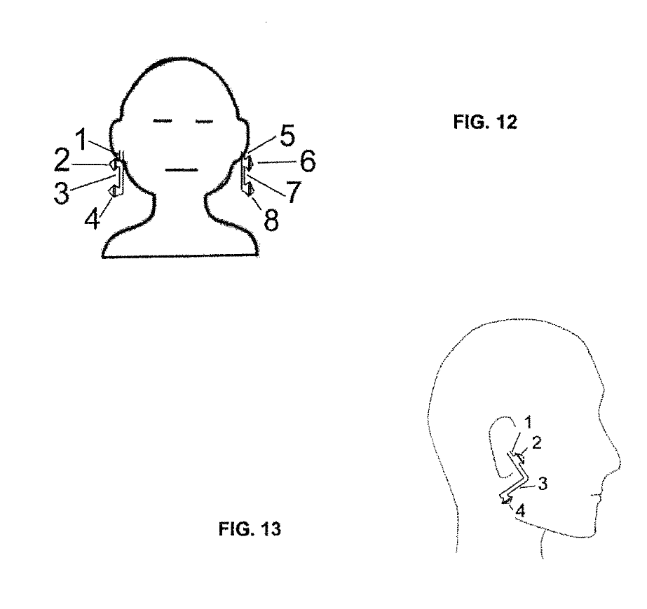

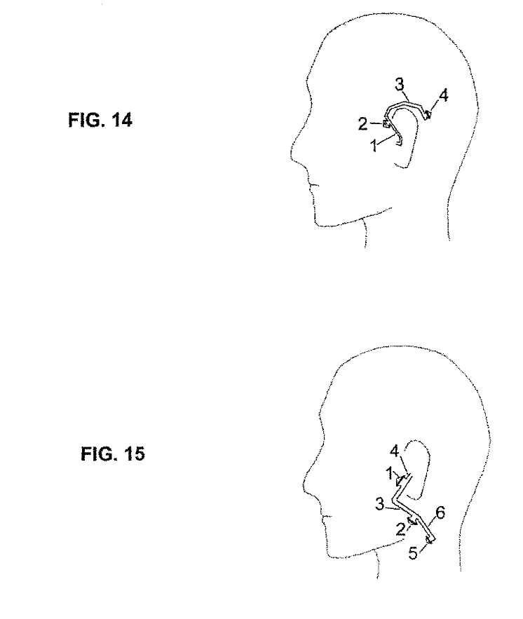

This technique can be applied to stereo and multichannel audio signals, as is illustrated in FIGS. 12 and 13. For example, to create the perception of stereo signals that are to the left and right of the user, the right hand channel is fed to a right speaker 2 (adjacent right outlet 1) and a left speaker 8 (distant from left outlet 5). The left hand channel is fed to a left speaker 6 (adjacent left outlet 5) and a right speaker 4 (distant from right outlet 1). The equivalent sound generated by the right hand channel speakers 2 and 8 will have different paths to travel through tubing 3 and 7, respectively, creating a timing difference. Likewise, the equivalent sound generated by the left hand channel speakers 4 and 6 will have different paths to travel through tubing 3 and 7, respectively, again creating a timing difference. The structure can also be placed over the ear as illustrated in FIG. 14.

Any number of speakers can be employed in embodiments of this aspect of the present invention. For example, as shown in FIG. 15, left 1, center 2, and right 5 channels can be assembled. On the opposite side of the user's head, the order would be reversed, with the right channel 5 closest to the user's ear.

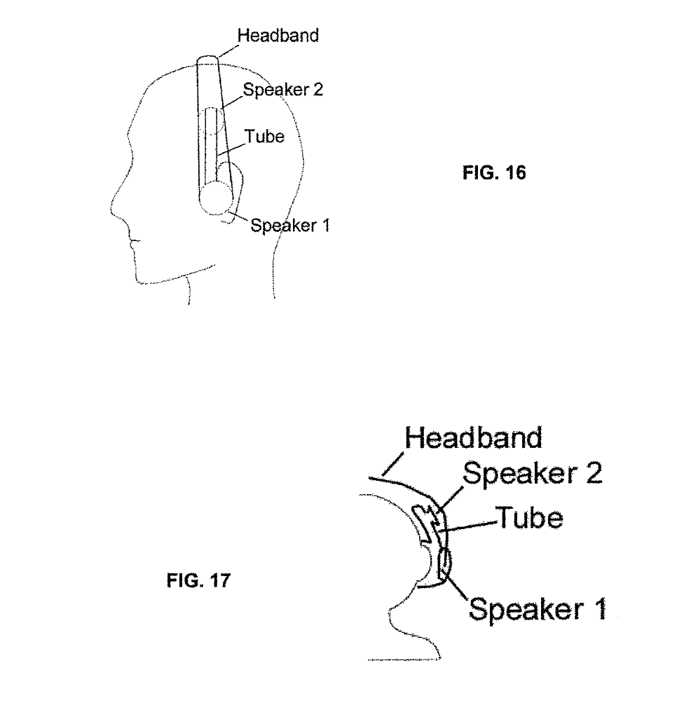

Referring now to FIGS. 16 and 17, it is clear that this technique is not limited to using small speakers and tubes that lead to the ear canal. The same technique can be applied using one speaker at or covering each ear, and a tube connecting to another speaker at an appropriate distance away. The technique could even be applied to traditional over-the-ear headphones with a tube and speaker added to each side.

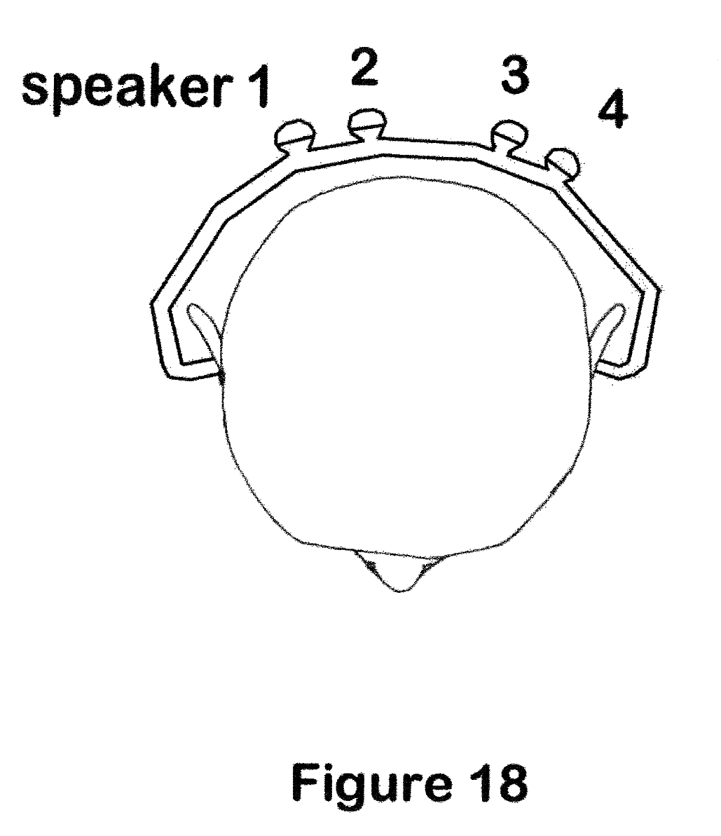

FIG. 18 shows an illustrative configuration that can be used for both EQ control or 360 degree surround.

For EQ control the right channel signal goes to speaker 1 and 2, the left channel signal goes to speaker 3 and 4. Speaker 2 and 3 have one frequency response curve and speaker 1 and 4 have a different frequency response curve. A volume control to speakers 1 and 4 allows the user to adjust the volume amplitude to those speakers. The volume control could also be connected to increase the volume to 1 and 4 while simultaneously reducing the volume control to 2 and 3, thus maintaining a constant overall volume amplitude.

The frequency response curve for speakers 2 and 3 can be such that they simulate the general frequency response curve for sounds arriving in front of the user. The characteristic of this is that the frequency response curve is biased with higher amplitudes in the higher frequencies. The frequency response curve for speakers 1 and 4 can be such that they simulate the general frequency response curve for sounds arriving from the rear of the user. The characteristic of this is that the frequency response curve is biased with higher amplitudes of the lower frequencies.

### 5 Speaker, Full Length Tube Headphone

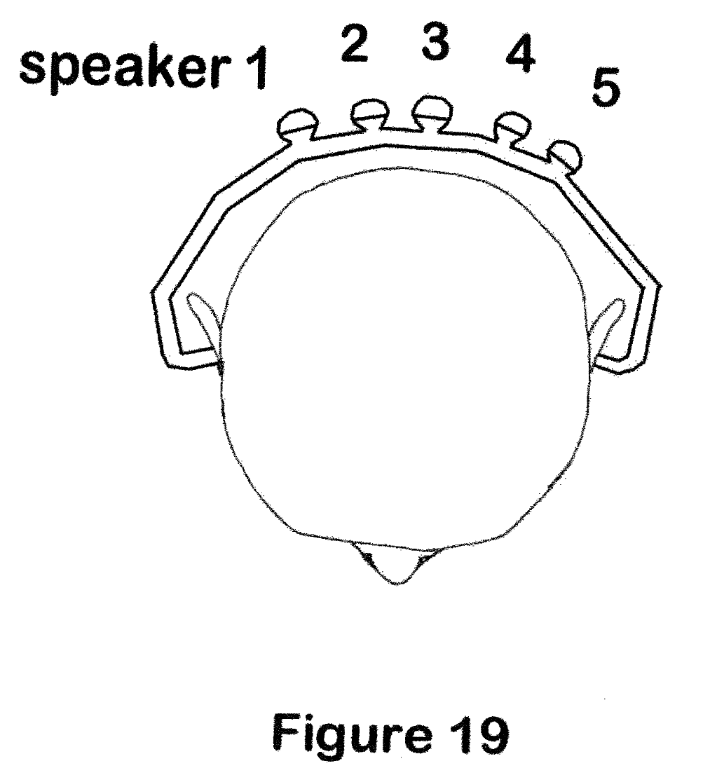

Shown in FIG. 19, this headphone illustrates a technique to create the perception of the sound moving around the user's head.

The spacing of the speakers is such that each represents an angle from the centerline of the head. So, for example, speaker 3 could be in the center and represent an angle of 0 degrees from centerline. The formula S=D/2 (A+sin(A)) can be used to place the speakers to represent sounds at +/−45 degrees and say +/−90 degrees.

To create the perception of the sound source moving, a sound signal is initially sent via a switch to one speaker. The switch decreases the amplitude, either gradually or suddenly, in the speaker while simultaneously increasing the amplitude in an adjacent speaker. In this way the sound source can be moved from one angle to another angle.

Using FIG. 19 for illustration, for a stereo example, the left channel could be sent to speaker 4 and the right signal to speaker 2. The switch would simultaneously move the right signal from speaker 2 to speaker 1 while moving the left signal from speaker 4 to speaker 3.

This movement can be coordinated with a head rotation sensor to move the angle of the sound so that the headphones could create the perception that the sound is stationary in the room instead of rotating with the head.

The table below shows which speaker receives which channel as the head is rotated, or the desired perceived angle of the sound relative to the head.

| | Left Channel goes to | Right Channel goes to |
|---|---|---|
| Head angle | speaker numbered | speaker numbered |
| 0 | 2 | 4 |
| 45 | 1 | 3 |
| 90 | 2 | 2 |
| 135 | 3 | 1 |
| 180 | 4 | 2 |
| 225 | 5 | 3 |
| 270 | 4 | 4 |
| 315 | 3 | 5 |
| 360, 0 | 2 | 4 |

The same effect can be created with the configuration of speakers with the sound path to each ear where each speaker of the 5 speakers is mounted on a tube for the left ear and the reverse order of the speakers is mounted on a tube for the right ear.

While particular embodiments of the present invention have been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiments. The invention is therefore to be considered limited solely by the scope of the appended claims.

1. A method of creating a net frequency response curve in a headphone apparatus, the method comprising:
providing at least a first and a second speaker for at least one channel of sound, the first speaker having a different frequency response curve to that of the second speaker;
providing a signal directly to each speaker without the use of a crossover circuit;
whereby the net frequency response curve is created based on the different frequency response curves of each speaker.

2. The method of claim 1, wherein either the first or second speaker has a volume control means for adjusting the amplitude of the associated speaker.

3. The method of claim 1, wherein more than one speaker has a volume control means for independently adjusting the amplitude of the associated speaker.

4. The method of claim 1, wherein a coupled volume control is provided for adjusting the amplitude of at least the first speaker and the second speaker in substantially opposite amplitudes so that the overall amplitude level is substantially maintained.

5. The method of claim 1, wherein the first speaker has an elevated amplitude for a first frequency band and the second speaker has an elevated amplitude for a second frequency band and wherein at least a portion of the first and second frequency bands do not overlap.

6. The method of claim 1, wherein two channels of sound are provided and each channel has at least two speakers, each having a different frequency response curve.

7. The method of claim 1, wherein at least three channels of sound are provided and each channel has at least two speakers, each having a different frequency response curve.

8. A method of providing an audio signal to a user in a headphone apparatus, the method comprising:
providing a headphone apparatus comprising at least one left speaker for a left ear of a user having a sound path from the left speaker to the left ear canal and at least one right speaker for a right ear of the user having a sound path from the right speaker to the right ear canal, wherein the sound path of the left speaker has a different length from the sound path of the right speaker; and
sending an audio signal simultaneously to the left speaker and right speaker thereby creating a timing difference in the time the signal is received by each ear canal based on the difference is the length of the sound path.

9. The method of claim 8, wherein the audio signal for the left and right speakers is the same.

10. A method of providing an audio signal to a user in a headphone apparatus, the method comprising:
providing at least two channels of audio signal; and
providing a headphone apparatus comprising a left speaker and a right speaker for each channel, each of the left speakers having a sound path from the left speaker to the left ear canal and each of the right speakers having a sound path from the right speaker to the right ear canal,
wherein the sound path for the left speaker of a channel has a different length than the sound path for the right speaker of the channel unless the channel is an audio signal for a center channel; and
wherein each channel is sent simultaneously to the corresponding left and right speaker associated with that channel.

11. The method of claim 10, wherein a first and a second audio channel are provided; the left speaker for a first audio channel has a sound path length of X, the right speaker for a first audio channel has a sound path length of Y, the left speaker for the second audio channel has a sound path length of Y and the right speaker for the second audio channel has a sound path length of X, and X is different from Y.

12. The method of claim 11, wherein a third audio channel is provided and is the center channel; the left and right speaker of the center channel each having substantially equal sound path lengths.

13. The method of claim 11, wherein speakers having equal sound path lengths have the same frequency response curve which is different to the frequency response curve of speakers having a different sound path length.

14. The method of claim 13, further comprising the step of: providing a volume control means for adjusting the amplitude of at least one pair of speakers having the same frequency response curve.

15. The method of claim 10, wherein a perceived sound angle from a center plane of a user's head is:
S=D/2(A+sin(A))
wherein:
S is the sound path length difference between the left and right speakers of a channel;
D is the diameter of a user's head; and
A is the perceived sound angle.

16. The method of claim 10, wherein the signal provided is a stereo signal and the headphone apparatus comprises two left speakers and two rights speakers.

17. The method of claim 10, wherein the signal is a 5.1 signal and the headphone apparatus comprises five left speakers and five right speakers.

18. The method of claim 17, wherein the headphone apparatus further comprises two base speakers.

19. The method of claim 10, wherein the center channel comprises a front center and a rear center channel.

20. A headphone apparatus having an ear cup for cupping a user's ear and an air circulation control device for circulating air to at least a portion of a user's ear when the headphone apparatus is in place on the user, the device comprising: an opening situated in the ear cup for allowing passage of air through the ear cup to at least a portion of a user's ear; means for at least partially blocking the opening.

21. The headphone apparatus of claim 20, wherein the means for at least partially blocking the opening is a removable cap adapted to fit into the opening and block air flow through the opening.

22. The headphone apparatus of claim 20, wherein the means for at least partially blocking the opening is an adjustable panel suitable for movement from an open position whereby the opening allows passage of air through the ear cup to at least a portion of a user's ear and a closed position whereby the panel is moved over the opening and either partially or fully blocks the opening.

23. A headphone having an ear cup for cupping a user's ear and an air circulation control device for circulating air to at least a portion of a user's ear when the headphone apparatus is in place on the user, the device comprising: a fan for blowing air; a duct having one end for directing air at the user's ear and another end in communication with the fan such that operation of the fan blows air into the duct and causes circulation of air to at least a portion of the user's ear.

24. The headphone of claim 23, wherein the duct is lined with sound-absorbing material.
